(19) United States
(12) Patent Application Publication
(10) Pub. No.: US 2016/0267594 A1
(43) Pub. Date: Sep. 15, 2016

(54) Community Reserves

(71) Applicant: Julie Ann Arzu, Yonkers, NY (US)

(72) Inventor: Julie Ann Arzu, Yonkers, NY (US)

(21) Appl. No.: 14/583,565

(22) Filed: Mar. 13, 2015

(51) Int. Cl. G06Q 40/06

(52) U.S. Cl. CPC G06Q 40/06

(57) ABSTRACT

This invention relates to a system and a method for securely managing community reserves. The system includes a software (Sengsoo) tailored for the rapid and efficient management and processing of community reserves. The system may provide the much needed oversight and stability to the community reserve process. The system may be used to vigorously assess, evaluate and verify that all information received by participants is accurate and legitimate. The system may make the community reserve process completely automated. The system may deliver accurate as well as punctual community reserves disbursements. The system may provide the opportunity for participants new to a community reserve to choose their desired disbursement date. The system may be used to secure existing community reserves and establish new reserves. The system may offer variations in disbursement cycles. The software may be used by the participants to access their community reserve accounts in order to monitor all transactions related to the community reserve.

### BACKGROUND OF THE INVENTION

This invention relates to a system and a method for securely managing the community reserve process. Thousands Of individuals participate in traditional community reserves all over the United States. It is a method used for monetary conservation and advancement in order to meet goals. Community reserves are commonly organized:
To help individual meet financial obligations
Weddings or Honeymoon expenses
Vehicles (down payments on new or used cars)
For down payments on a new homes or to stop foreclosures
Education purposes (for tuition or college loans)
Start a business or grow a business
Help out friends or family in need
Cosmetic surgery

Su-su, Partna, Kaes, Tanda and Sociedad are all names for traditional community reserves, which, are also known as money pools. In a money pool people collectively conserve funds on a weekly, biweekly or monthly basis until each person has had the chance to collect the funds.

Currently the word “Su-Su” is the term frequently used amongst most groups to describe a traditional community reserve. The issues with all traditional community reserves are they are unsecure, informal, lack proper oversight and limit its participants to cooperatives existing of only their closest associates, family or friends. There is not a binding contract in place between the organizer and the participants just simply a collective trust among the group. Having a collective trust among participants and organizer is a positive aspect however not having a binding contract causes a major concern for the reserve's vitality.

Traditional community reserves are not organized by official and legal business entities and generally operate as follows:
1. A group of individuals (family, friends, coworkers or business owners) with a collective trust decide to organize a community reserve.
2. The group decides when the community reserve will begin.
3. The group determines the community reserve's amount, the contribution amount and the contribution and disbursement frequency (weekly, bi-weekly or monthly).
4. The group appoints a representative from the group. The representative is often referred to as the banker his/her role is analogous to a treasurer, bookkeeper or accountant. The responsibility of the representative is to collect the participants' funds and distribute the funds.
5. The participants choose a disbursement date. Most groups select dates based on urgency and seniority, therefore new participants always receive their disbursement at the latter end of the reserve.
6. If the organizer is compensated for their service then the organizer may receive a percentage of the community reserve's amount. Some organizers are not paid for their service however most are. The organizer informs the participants before the reserves begin how much he/she expects to be compensated.

Traditional community reserves do not address the following questions or concerns:
1. What happens to a participant's disbursement in the event of death?
2. What happens to the traditional community reserve if a participant fails to make their contribution or is unable to meet their future obligations?
3. If a participant fails to make their contribution or is unable to meet their future obligations then can the community reserve continue to operate successfully and if so, at what cost?

An issue, which is of great concern, is the organizer's improper securing of participants' contributions for disbursement. The organizer collects all contributions and usually waits at home for the participant to pick up their cash distribution or the organizer personally delivers the cash distribution to the participant. Another concern is that some participants may not all be legally employed which increases the risk of participants not being able to fulfill their commitment. Any participants' failure or inability to make their contribution burdens the appointed representative with the responsibility of supplementing the difference or asking the other participants to increase their contribution amounts. This leaves the participants with the option of either supplementing the difference or enduring the collapse of the community reserve. Traditional community reserves do not guarantee receipt of participants' disbursement. The final issue is that all new participants are unable to select their distribution date. New participants always receive their disbursement towards the latter end of the reserve. An example of traditional community reserves with friends, family or employees is shown below:

Participants: 10

Community Reserves' Sum: $5000

Cycle: 10

Shares: 10

Bi-Weekly Contribution per Share: $500

Transactions:

### Cycles 1-10

The reserves' organizer collects the contribution(s) from the participants biweekly.
The first participant receives $5,000 (10 shares).
Two weeks later the second participant receives $5,000 (10 shares) and so forth until all participants receives their distribution(s).

### SUMMARY OF THE INVENTION

1. This invention relates to a system and a method for securely managing community reserves. The system includes a software (Sengsoo) tailored for managing and processing community reserves rapidly and efficiently.

2. The system may provide the much needed oversight and stability to the community reserve process.

3. The system may provide a trustworthy service that is safe, convenient and reliable.

4. The system may be used to vigorously assess, evaluate and verify that all information (i.e. employment, banking information) received by participants is accurate and legitimate.

5. The system may make the community reserve process completely automated, and may reduce the risk associated with community reserves.

6. The system may allow for easy monitoring and delivery of the community reserve process.

7. The system may deliver accurate as well as punctual community reserves disbursements.

8. The system may provide the opportunity for new participants to choose their desired disbursement date.

9. The system may make it easier to participate in community reserves.

10. The system may provide the highest level of service that is client centered, community focused and reliable.

11. The system may make it easier to create or sustain vibrant and healthy community reserves.

12. The system may be used to secure existing community reserves as well as establish new reserves.

13. The system may offer variations in disbursement cycles.

14. The system may be used by participants to access their community reserve accounts and may make it easier for participants to monitor all community reserves activities.

15. The system may obtain all participants beneficiaries, which allow for beneficiaries to receive the participants' disbursement in the event of their death. The various advantages of this invention will become more apparent to participants who are familiar with the community reserve process and the risks associated with current traditional community reserves.

### DESCRIPTION OF THE DRAWINGS

FIG. 1 Displays the application and verification process

FIG. 2 Displays the confirmation process

FIG. 3 Displays the start of the actual community reserve process

FIG. 4 Displays the final process in the community reserve process

FIG. 5 Displays participant access to other services in the system

FIG. 6 Displays a cycle in a traditional community reserve

FIG. 7 Displays the community reserve's administrative fee cycle 1

FIG. 8 Displays the community reserve's first security deposit cycle 2

FIG. 9 Displays the community reserve's second security deposit cycle 3

FIG. 10 Displays the community reserve's disbursement cycle 4 (1^{st} Distribution)

FIG. 11 Displays the community reserve's disbursement final cycle (Final Distribution)

### DETAILED DESCRIPTION OF THE INVENTION

Brass & Thornton Community Reserves, Inc., has developed an innovative concept known as a Community Cooperative (the “Cooperative”). The Cooperative is best described as a Community Reserve with a structured conservation plan that provides participants with access to and use of funds. Like traditional reserves participants collectively conserve money however unlike traditional reserves Brass and Thornton offers a service that is entirely automated; in addition participants make periodic contributions into a secured common bank account. Subject to certain terms and conditions, each participant will have an opportunity to access and utilize the funds for personal financial needs.

Traditional community reserves fail to have certain security measures in place to protect their participants. Most traditional community reserves yield the risk of non-contribution or late contribution by active participants. This may result in the collapse of the community reserve and in many participants losing their money and not successfully meeting their goals. Brass & Thornton Community Reserves, Inc. realized that there is a need for community reserves to be delivered electronically, to be standardized, consisting of binding contracts, ACH withdrawals, direct deposits, and the ability to track participants' activities.

Brass & Thornton Community Reserves, Inc., may serve as the company that offers a centralized location for customers to partake in community reserves through the use of Sengsoo. Sengsoo, is a unique and innovative software wish may be used to efficiently deliver the community reserve process. This sophisticated and secure online software may be used to process all community reserve participants' information. The software may be used to assess, evaluate and verify that all information received by participants is accurate and legitimate; to process and track all transactions related to the reserve and much more. The service will be initially offered to employees then eventually to businesses.

The following is a list of actions that are involved when a group of employees choose to organize a community reserve (Option 1) or an individual employee chooses to join a reserve (Option 2) with Brass & Thornton Community Reserves, Inc.:

Option 1 Group
1. Group of employees (applicants) chooses to organize a community reserve
2. Applicants choose the reserve's amount.
3. Applicants decide on the type of community reserve organized (single disbursement, multi-disbursement or single/multi-disbursement).
4. Applicants select a start date from a range of start dates
5. The online software generates the number of shares, bi-weekly contribution (after tax dollars) and cycles required to efficiently manage the reserve client desires.
6. All necessary documentation is submitted.
7. All information is assessed, analyzed and verified (i.e. place of employment, address, SS, banking information, income status etc.).
8. The software generates the contribution and distribution dates.

Option 2 Individual
1. An individual employee choose to join a community reserve.
2. The applicant selects a reserve amount he/she wishes to participate in.
3. The applicant selects the type of community reserves he/she desires to join (single disbursement, multi-disbursement or single/multi-disbursement).
4. The applicant selects desired start date from a range of dates.
5. The online software generates the number of shares, bi-weekly contribution (after tax dollars) and cycles required to efficiently manage the reserve client desires.
6. All potential participants will be grouped together based on their desired request.
7. The applicant will be notified that his/her desired request has been found
8. All necessary documentation is submitted.
9. All information is assessed, analyzed and verified (i.e. place of employment, address, SS, banking information, income status etc.).
10. The software generates the contribution and distribution dates.

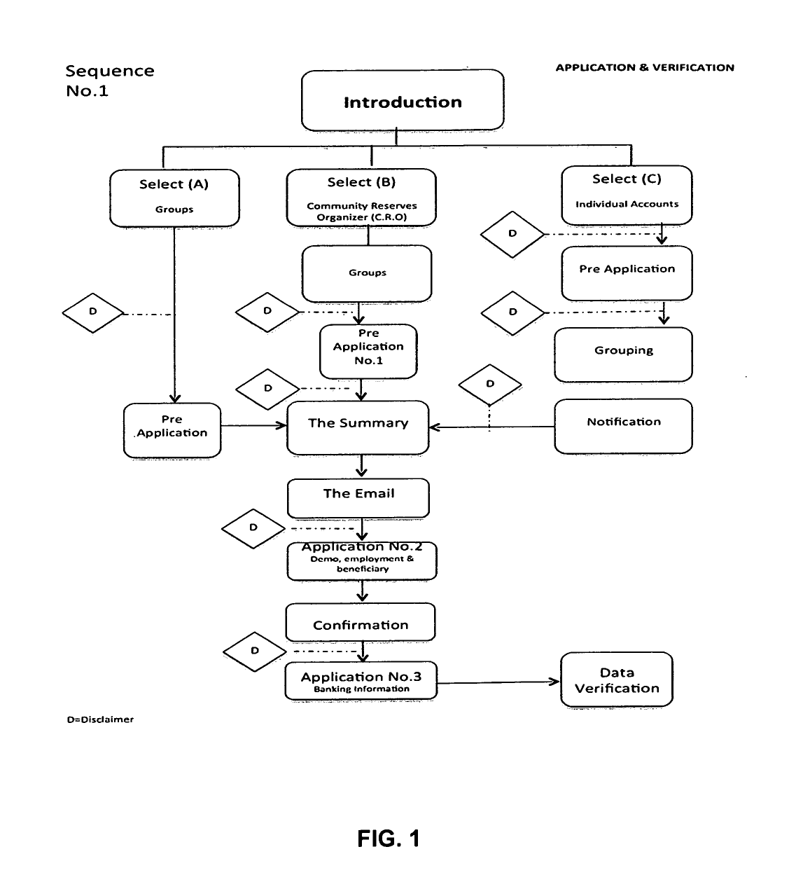

The system may fall under the following United States Patent Classifications: 705 and 902. FIG. 1 of the system's software (Sengsoo) begins with the first sequence, which is the application and verification process. This first sequence in the software begins with a three-part application process that involves the submission of all required information for processing and verification. The initial application is the pre-application process for a group (group of employees) or individual wishing to participate in a community reserve.

The initial application for a group involves one person from the group of employees to set up an account and process the fellow employees name and emails or

a Brass & Thornton's Community Reserve Organizer (CRO) processes the employees name and emails. The pre-application process also involves the lead employee or the CRO listing the employees in order of desired disbursement date (or the software can auto select), selecting the reserves' amount, selecting the start date and the type of reserve the group wishes to organize. There are 2 types of reserves, a single disbursement or single/multi-disbursement community reserve.

The pre-application for an individual (single employee) wishing to participate in a community reserve involves setting up an account, selecting the desired reserve amount from a range of amounts; selecting the desired disbursement (disbursement cycles 1-10): a primary, secondary and tertiary (applicant is informed that their primary requests will try to be honored however if not then their alternatives or their registration date will be used to determine the disbursement cycle); the applicant must also select the desired start dates from the range of dates and the type of reserve the individual wishes to join.

The system groups together individuals with the same requests.

The system notifies the applicants via email if their desired community reserve request was found or if not then the system will make recommendations.

The online software generates a summary: the number of shares, bi-weekly contribution (after tax dollars) and cycles required to efficiently manage the reserve and the fee that will be charged based on the applicant's scheduled disbursement.

An email is sent to every applicant containing the link to the website and a temporary password. The applicant's email address is the username. Client will be prompt to change password, agree to the number of shares, contribution schedule and the administrative fee. Client will also be prompt to start Application 2

The second application involves the processing of demographic information, employment information, disbursement preference (bank deposit verses check) and beneficiaries.

The system confirms that participants can afford to participate in the community reserve or will a lower reserve be suitable.

The third application is the submission of banking information.

The final step in this sequence is the thorough verification of all the information, submitted in Applications 1 & 2.

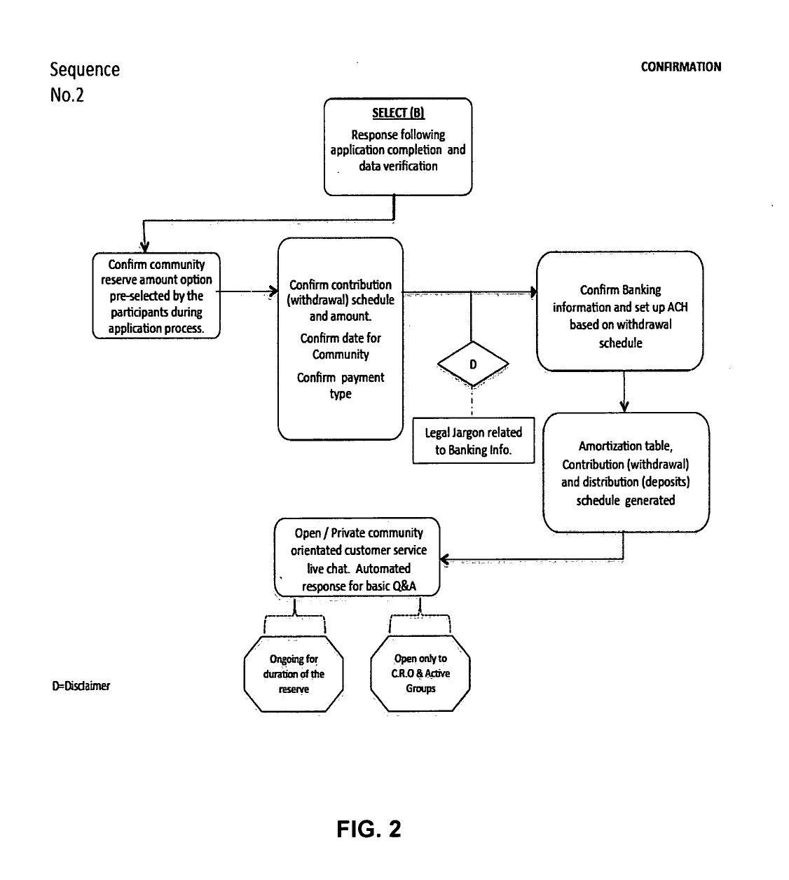

The second sequence FIG. 2 in the system is the confirmation process.

The reserve amount is confirmed.

The withdrawal amount is confirmed, the start date is confirmed and the form of disbursement (bank deposit or check) is confirmed.

The banking information is confirmed and the ACH set up is completed.

A calendar is generated containing the date and amount to be withdrawn and deposited from participants' accounts as well as the amortization table is generated. The amortization tables are shown on Table 3-Table 5 below on page 16.

Live chats will be available to participants throughout the life of the reserve.

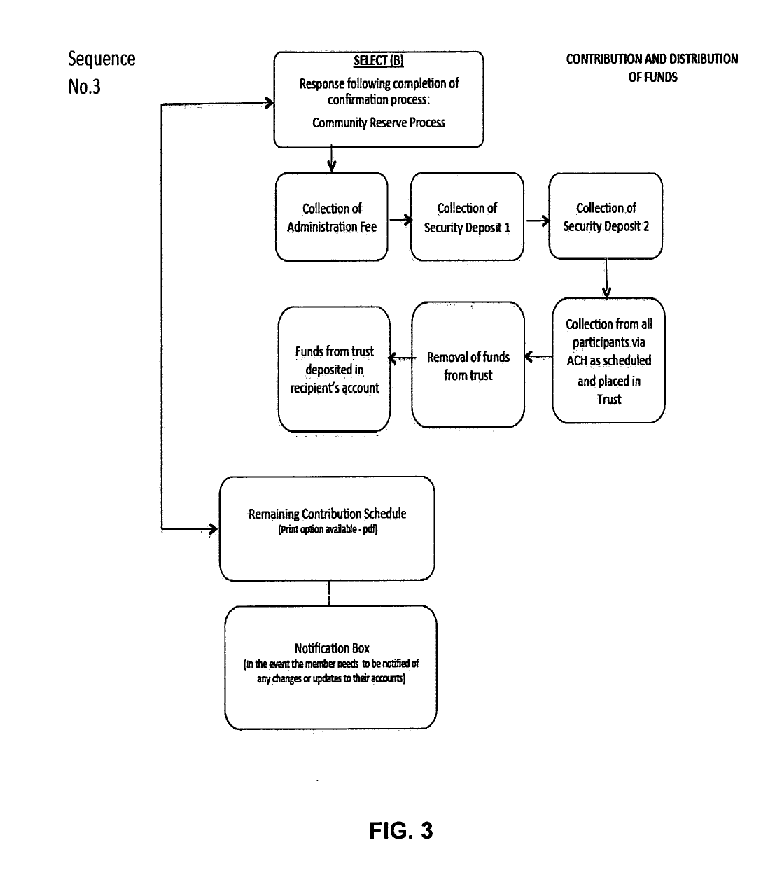

In the third sequence FIG. 3 the community reserve is ready to begin. Participants receive their disbursement only after three consecutive withdrawal cycles.

The administrative fee cycle is the first withdrawal cycle; it is also displayed on pages 14 & 15 in Tables 1 & 2-Columns 7 & 8 and page 16 in Table 3-Column 2.

The 1^{st} security deposit cycle is the second withdrawal cycle.

The 2^{nd} security deposit cycle is the third withdrawal cycle. The security deposit cycles are displayed on page 16 in Table 3-Columns 3 & 4. The security deposits are placed in a trust. After the three consecutive contributions the first recipient receives his/her disbursement on the 4^{th} cycle.

Contributions are collected from all participants and placed in the trust; the cycle's recipient(s) does not contribute during the distribution cycle.

The funds are withdrawn from the trust.

The funds are deposited in the recipient(s) account(s). This sequence occurs repetitiously for the life of the community reserve except for the final distribution. The transactions can be viewed on page 16 in Tables 3-5 between columns 6 and 29. At any time participants can view the remaining

contribution schedule and any

notifications.

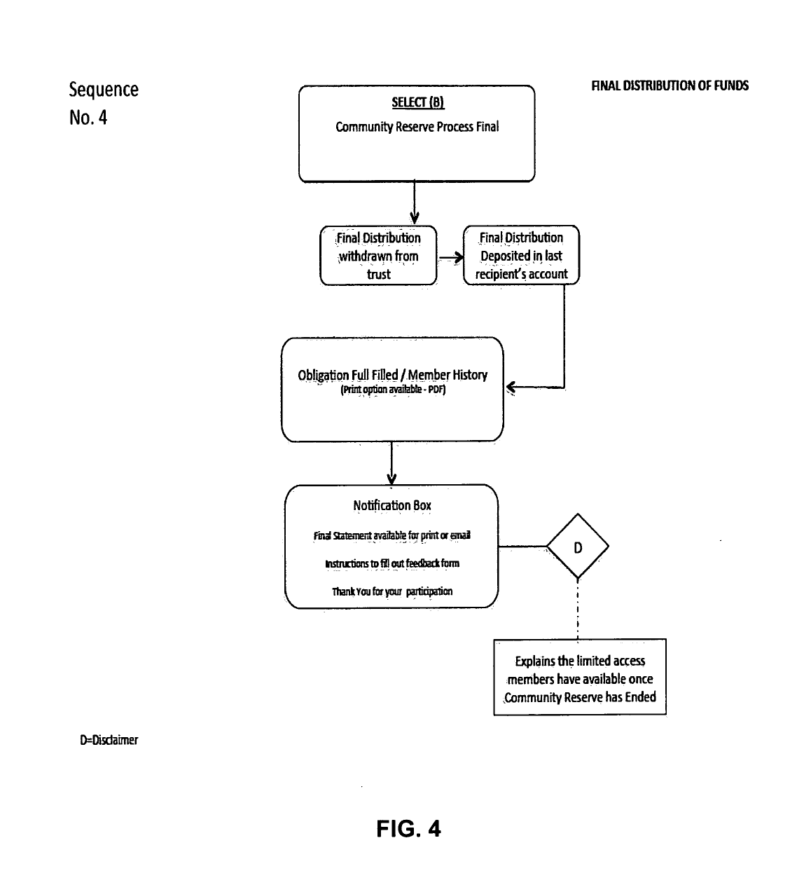

The 4^{th} sequence FIG. 4 of the system is the final stage of the community reserve process. In this sequence the last disbursement is made to the final recipient. In this cycle neither the recipient(s) nor the other participants contribute to the reserve.

The final funds in the trust are withdrawn.

The funds are deposited in the final recipient(s)' account(s). The final transaction can be viewed on page 16 in Table 5 in columns 29 & 30.

The participants' obligation is fulfilled and

a final notification is sent to all participants.

Limited access to the system will be given to all participants because the reserve has ended.

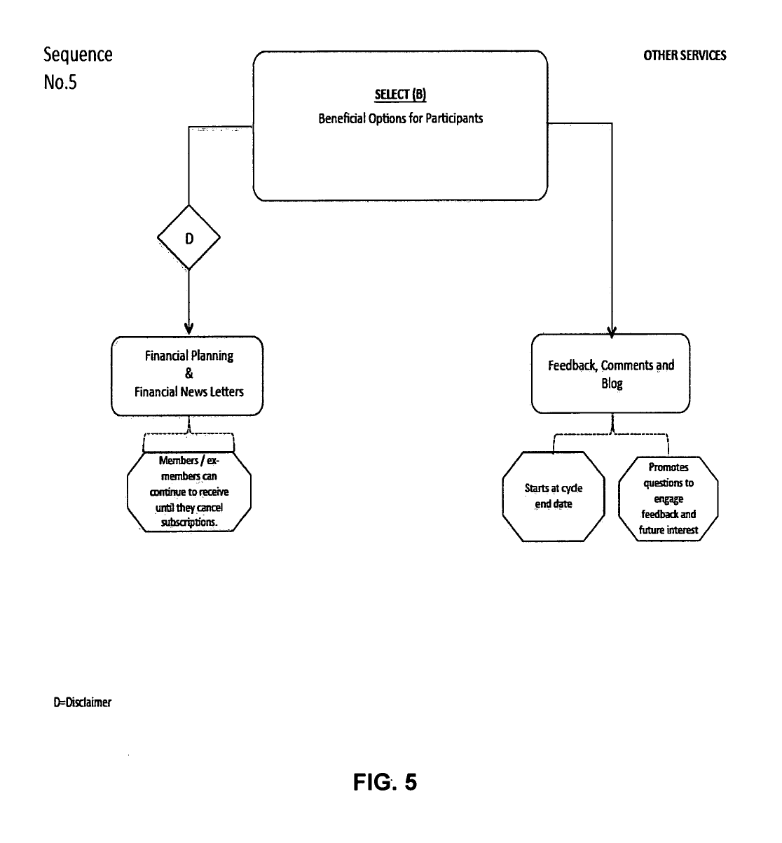

FIG. 5 displays beneficial services in the system, which clients will have access to.

Financial planning and recommended sites as well as financial newsletters will be services participants can access.

Feedback may be offered by participants.

As aforementioned there are 2 types of reserves: a single disbursement (Table 1 on Page 14) and single/multi-disbursement community reserve (Table 2 on Page 15). In a single disbursement community reserve, one participant receives all shares per cycle and the community reserve's disbursement amount is equal for all participants (Table 1-Column 5 on Page 14). In a single/multi-disbursement community reserve the shares are distributed to a single participant or multiple participants per distribution cycle; if there are multiple participants in a distribution cycle then the shares may be equal or different for each participant; however the total or sum of the community reserve's disbursement remains the same (Table 2-Column 5 on Page 15). Examples 1 & Example 2 on pages 17 and 18 are examples of both single and single/multi-disbursement reserves conducted at a medical clinic.

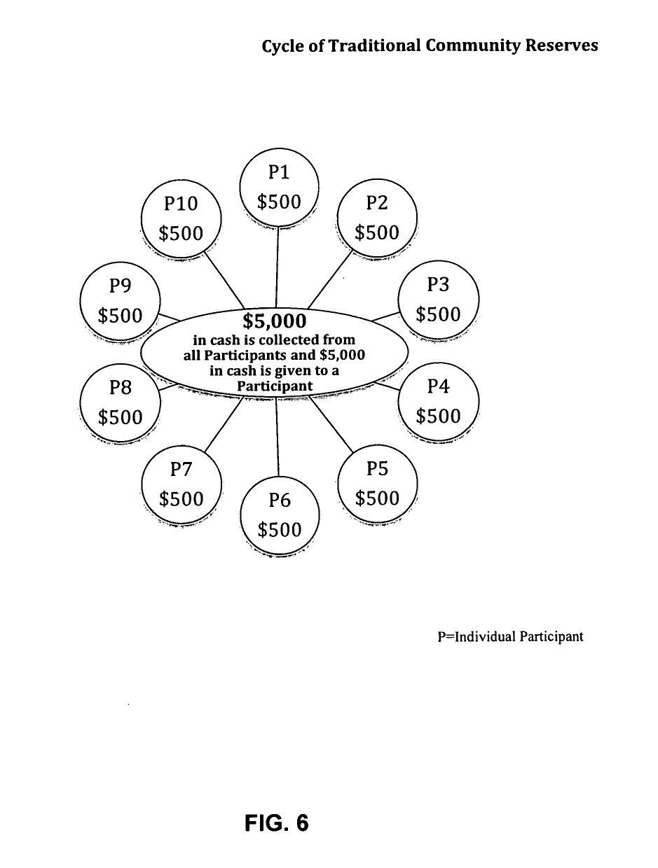

FIG. 6 is an example of a community reserve cycle with a traditional community reserve organizer; there are not any binding contracts; there are not any standard fees upfront or security deposits required. Participants simply hand cash to the traditional community reserve organizer and the organizer hands it to the recipient. This process continues until all participants have received their turn.

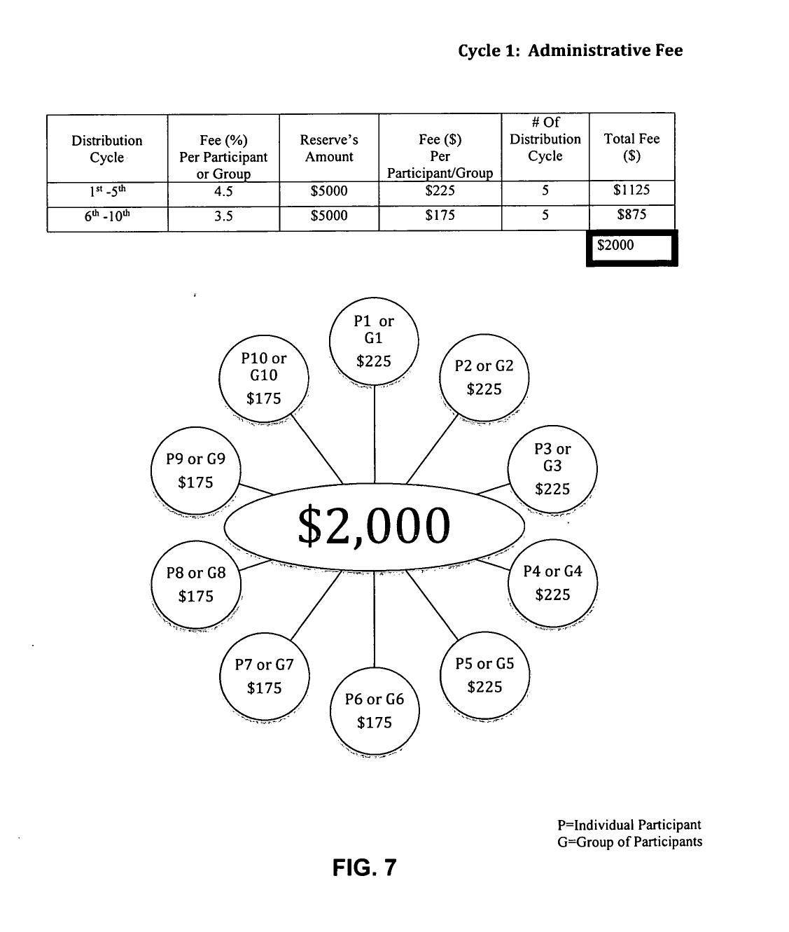

FIG. 7 displays how the administrative fee is calculated. Participant(s) who receive their distribution in the first half of the life of the community reserve are charged 4% and those receiving their funds in the second half are charged 3%.

The admin fee cycle is the 1^{st} cycle in the reserve process.

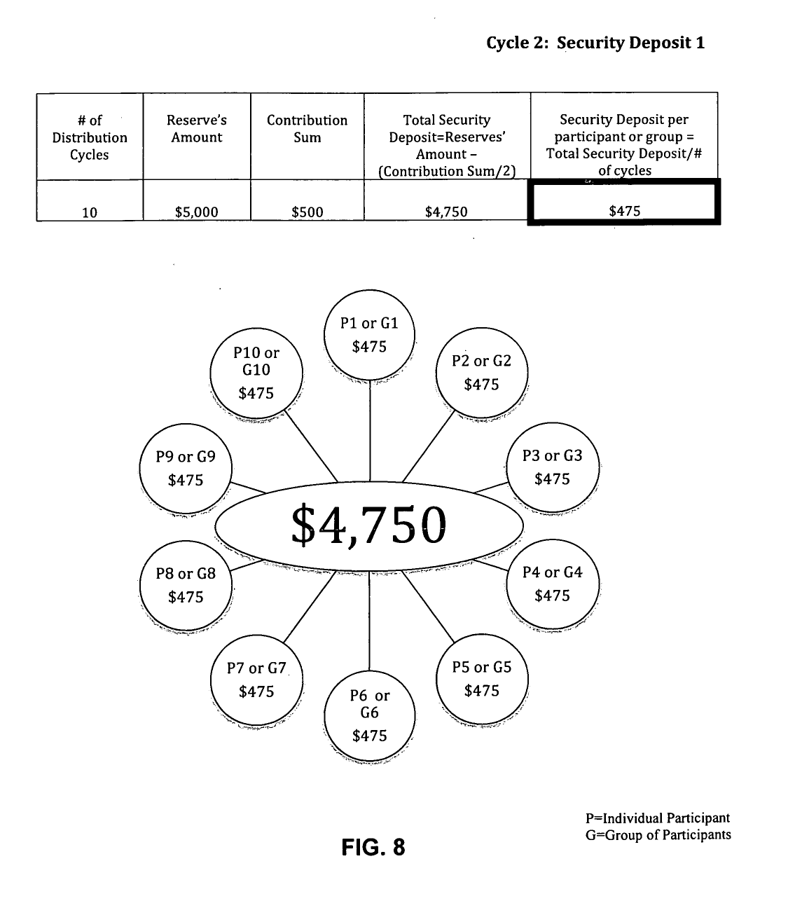

FIG. 8 The security deposit amount is determined by a formula developed by Brass and Thornton.

Displays the second cycle in the reserve, which is the collection of the 1^{st} security deposit, which is placed in a trust.

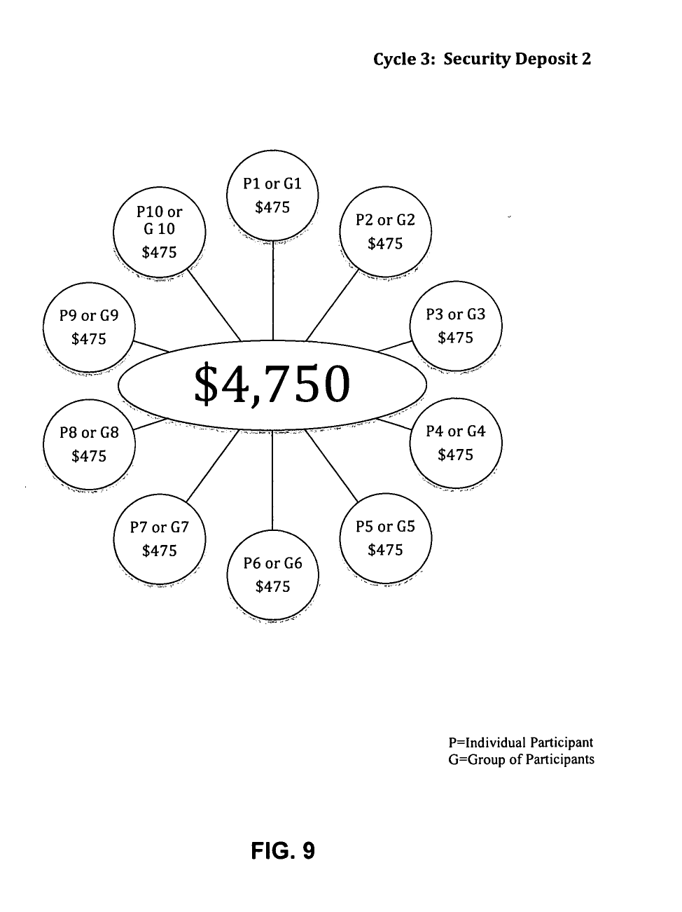

FIG. 9 displays the third cycle, which is the collection of the 2^{nd} security deposit, which is also placed in trust.

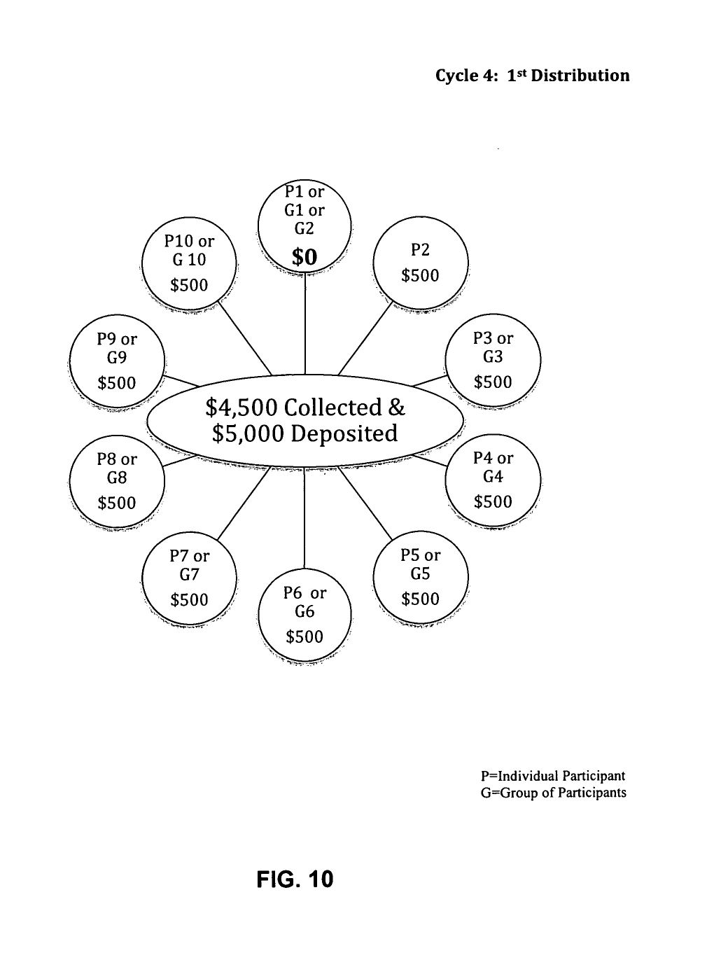

FIG. 10 displays the 4^{th} contribution cycle and 1^{st} distribution cycle in a reserve. As aforementioned during this cycle funds are collected from all participant(s) except from the participant(s) receiving the funds. The recipients(s) contribution is removed from the security deposit in trust, which completes the sum of the reserves' amount. This sequence occurs with all proceeding cycles except for the last cycle.

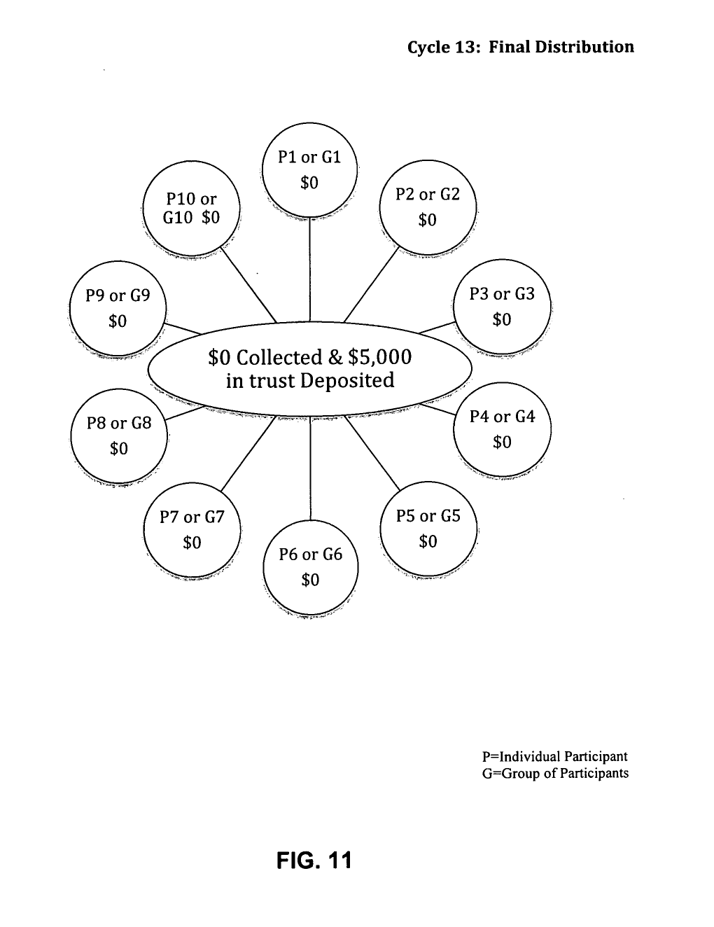

FIG. 11 displays the final cycle in the reserve and the final distribution cycle. In this cycle none of the participant(s) contribute including the recipient(s); the recipient(s) receives the remaining security deposit funds in the trust.

TABLE 1
Single Disbursement Community Reserve

| Number of Shares/Cycles | Bi-Weekly Contribution | Community Reserves' Amount |
|---|---|---|
| 1 | $500 | $5,000 |

| | 2 | | 4 | | | | |
|---|---|---|---|---|---|---|---|
| 1 | # Of | 3 | Bi-Weekly | 5 | 6 | 7 | 8 |
| Distribution | Participant(s) | Participant | Contribution | Disbursement (s) | Fee %/ | Fee % of | $ Fee per |
| Cycle | per Cycle | # | $500 | $5,000 | Participant | Disbursement | Person |
| 1 | 1 | 1 | $500 | $5,000 | 4.5 | 4.5 × 5000 | $225.00 |
| 2 | 1 | 2 | $500 | $5,000 | 4.5 | 4.5 × 5000 | $225.00 |
| 3 | 1 | 3 | $500 | $5,000 | 4.5 | 4.5 × 5000 | $225.00 |
| 4 | 1 | 4 | $500 | $5,000 | 4.5 | 4.5 × 5000 | $225.00 |
| 5 | 1 | 5 | $500 | $5,000 | 4.5 | 4.5 × 5000 | $225.00 |
| 6 | 1 | 6 | $500 | $5,000 | 3.5 | 3.5 × 5000 | $175.00 |
| 7 | 1 | 7 | $500 | $5,000 | 3.5 | 3.5 × 5000 | $175.00 |
| 8 | 1 | 8 | $500 | $5,000 | 3.5 | 3.5 × 5000 | $175.00 |
| 9 | 1 | 9 | $500 | $5,000 | 3.5 | 3.5 × 5000 | $175.00 |
| 10 | 1 | 10 | $500 | $5,000 | 3.5 | 3.5 × 5000 | $175.00 |
| | | | | | | | $2000.00 |

TABLE 2
Single/Multi-Disbursement Community Reserve

| Number of Shares per Cycle | Bi-Weekly Contribution | Community Reserves' Amounts |
|---|---|---|
| 1 | $125 | $1250 |
| 2 | $250 | $2500 |
| 3 | $375 | $3750 |
| 4 | $500 | $5,000 |

| | | | 4 | | | | |
|---|---|---|---|---|---|---|---|
| | 2 | | Bi-Weekly | 5 | | | |
| 1 | # Of | 3 | Contribution | Disbursement(s) | 6 | 7 | 8 |
| Distribution | Participant(s) | Participant | per Participant | Sum = | Fee %/ | Fee % of | $ Fee per |
| Cycle | per Cycle | # | Sum = $500 | $5,000 | Participant | Disbursement | Person |
| 1 | 1 | 1 | 1. $500 | 1. $5000 | 4.5 | 4.5 × 5000 | $225 |
| 2 | 2 | 2 | 1. $250 | 1. $2,500 | 4.5 | 4.5 × 2500 | $112.50 |
| | | 3 | 2. $250 | 2. $2,500 | | 4.5 × 2500 | $112.50 |
| 3 | 3 | 4 | 1. $125 | 1. $1,250 | 4.5 | 4.5 × 1250 | $56.25 |
| | | 5 | 2. $125 | 2. $1,250 | | 4.5 × 1250 | $56.25 |
| | | 6 | 3. $250 | 3. $2,500 | | 4.5 × 2500 | $112.50 |
| 4 | 4 | 7 | 1. $125 | 1. $1,250 | 4.5 | 4.5 × 1250 | $56.25 |
| | | 8 | 2. $125 | 2. $1,250 | | 4.5 × 1250 | $56.25 |
| | | 9 | 3. $125 | 3. $1,250 | | 4.5 × 1250 | $56.25 |
| | | 10 | 4. $125 | 4. $1,250 | | 4.5 × 1250 | $56.25 |
| 5 | 2 | 11 | 1. $125 | 1. $1,250 | 4.5 | 4.5 × 1250 | $56.25 |
| | | 12 | 2. $375 | 2. $3,750 | | 4.5 × 3750 | $168.75 |
| 6 | 2 | 13 | 1. $500 | 1. $5000 | 3.5 | 3.5 × 5000 | $175.00 |
| 7 | 3 | 14 | 1. $125 | 1. $1,250 | 3.5 | 3.5 × 1250 | $43.75 |
| | | 15 | 2. $125 | 2. $1,250 | | 3.5 × 1250 | $43.75 |
| | | 16 | 3. $250 | 3. $2,500 | | 3.5 × 2500 | $87.50 |
| 8 | 4 | 17 | 1. $125 | 1. $1,250 | 3.5 | 3.5 × 1250 | $43.75 |
| | | 18 | 2. $125 | 2. $1,250 | | 3.5 × 1250 | $43.75 |
| | | 19 | 3. $125 | 3. $1,250 | | 3.5 × 1250 | $43.75 |
| | | 20 | 4. $125 | 4. $1,250 | | 3.5 × 1250 | $43.75 |
| 9 | 1 | 21 | 1. $500 | 1. $5000 | 3.5 | 3.5 × 5000 | $175.00 |
| 10 | 1 | 22 | 1. $500 | 1. $5000 | 3.5 | 3.5 × 5000 | $175.00 |
| | | | | | | | $2000.00 |

TABLE 3
Cycles 1-5

| | | 3 | 4 | 5 | | | | | |
|---|---|---|---|---|---|---|---|---|---|
| 1 | 2 | Security in | Security in | Total Security in | 6 | 7 | 8 | 9 | 10 |
| Cycles | Admin Fees | Trust | Trust | Trust | Participant | Contributions | Trust | Contributions | Trust |
| 1 | $2,000 | | | | | | $4,500 | | $4,500 |
| 2 | | $4,750 | | | | | $9,500 | | $9,000 |
| 3 | | | $4,750 | $9,500 | | | | | |
| 4 | | | | | 1 | 0 | ($5,000) | $500 | |
| 5 | | | | | 2 | $500 | | 0 | ($5,000) |
| | | | | | 3 | $500 | | $500 | |
| | | | | | 4 | $500 | | $500 | |
| | | | | | 5 | $500 | | $500 | |
| | | | | | 6 | $500 | | $500 | |
| | | | | | 7 | $500 | | $500 | |
| | | | | | 8 | $500 | | $500 | |
| | | | | | 9 | $500 | | $500 | |
| | | | | | 10 | $500 | | $500 | |
| | | | | | | $4,500 | $9,000 | $4,500 | $8,500 |

TABLE 4
Cycles 6-9

| 11 | 12 | 13 | 14 | 15 | 16 | 17 | 18 | 19 | 20 |
|---|---|---|---|---|---|---|---|---|---|
| Cycles | Participant | Contribution | Trust | Contribution | Trust | Contribution | Trust | Contribution | Trust |
| | | | $4,500 | | $4,500 | | $4,500 | | $4,500 |
| | | | $8,500 | | $8,000 | | $7,500 | | $7,000 |
| | 1 | $500 | | $500 | | $500 | | $500 | |
| | 2 | $500 | | $500 | | $500 | | $500 | |
| 6 | 3 | 0 | ($5,000) | $500 | | $500 | | $500 | |
| 7 | 4 | $500 | | $0 | ($5,000) | $500 | | $500 | |
| 8 | 5 | $500 | | $500 | | $0 | ($5,000) | $500 | |
| 9 | 6 | $500 | | $500 | | $500 | | $0 | ($5,000) |
| | 7 | $500 | | $500 | | $500 | | $500 | |
| | 8 | $500 | | $500 | | $500 | | $500 | |
| | 9 | $500 | | $500 | | $500 | | $500 | |
| | 10 | $500 | | $500 | | $500 | | $500 | |
| | | $4,500 | $8,000 | $4,500 | $7,500 | $4,500 | $7,000 | $4,500 | $6,500 |

TABLE 5
Cycles 10-13

| 21 | 22 | 23 | 24 | 25 | 26 | 27 | 28 | 29 | 30 |
|---|---|---|---|---|---|---|---|---|---|
| Cycles | Participant | Contributions | Trust | Contributions | Trust | Contributions | Trust | Contributions | Trust |
| | | | $4,500 | | $4,500 | | $4,500 | | $0 |
| | | | $6,500 | | $6,000 | | $5,500 | | $5,000 |
| | 1 | $500 | | $500 | | $500 | | $0 | |
| | 2 | $500 | | $500 | | $500 | | $0 | |
| | 3 | $500 | | $500 | | $500 | | $0 | |
| | 4 | $500 | | $500 | | $500 | | $0 | |
| | 5 | $500 | | $500 | | $500 | | $0 | |
| | 6 | $500 | | $500 | | $500 | | $0 | |
| 10 | 7 | $0 | ($5,000) | $500 | | $500 | | $0 | |
| 11 | 8 | $500 | | $0 | ($5,000) | $500 | | $0 | |
| 12 | 9 | $500 | | $500 | | $0 | ($5,000) | $0 | |
| 13 | 10 | $500 | | $500 | | $500 | | $0 | ($5,000) |
| | | $4,500 | $6,000 | $4,500 | $5,500 | $4,500 | $5,000 | $0 | $0 |

### EXAMPLE 1

### Single Disbursement Community Reserve at Green's Medical Center Clinic

Participants: 10 Staff Members

Cooperative's Sum: $5,000

Cycle: 13

Shares: 10

Bi-Weekly Contribution per Share: $500 (except for the last cycle)

Sum of Contribution: $500

Transactions

1^{st} Cycle
$2000 (Admin Fees) Collected

2^{nd} Cycle
$4750 (Security) Collected
Security placed in trust

3^{rd} Cycle
$4750 (Security) Collected
Security placed in trust

4^{th}-12^{th} Cycles
$500 collected from all participants except from the cycle's recipient.
$4,500 is collected and placed in the trust.
$4,500+Security Deposit in Trust
$5,000 withdrawn from the trust then deposited in recipient's acct.

13^{th} Cycle
Nothing is collected from any participant
$5,000 remaining in trust will be deposited in last recipient's account

### EXAMPLE 2

### Single/Multi-Disbursement Community Reserve at Green's Medical Center Clinic

Participants: 22 Staff Members

Cooperative Sums: $5,000

Disbursement Cycles: 10

Total Cycles: 13

Shares: 40 (4 Shares/Disbursement Cycles)

Contribution per Share: $125

Bi-weekly Contribution(s):

$125 (25%=$1250),

$250 (50%=$2500),

$375 (75%=$3750) or

$500 (100%=$5000)

(Contribution based on number of shares)

Sum of the Contributions: $500

Transactions

1^{st} Cycle
$2000 (Admin Fees) Collected

2^{nd} Cycle
$4750 (Security) Collected
Security placed in trust

3^{rd} Cycle
$4750 (Security) Collected
Security placed in trust

4^{th}-12^{th} Cycles
$500 collected from all participants except from the cycle's recipient.
$4,500 is collected and placed in the trust.
$4,500+Security Deposit in Trust
$5,000 withdrawn from the trust then deposited in recipient's acct.

13^{th} Cycle
Nothing is collected from any participant
$5,000 remaining in trust will be deposited in last recipient's account

What is claimed is:

1. A system and method for organizing, delivering and managing the community reserve process. The system comprising of software that collects potential clients data (employment, SS, banking) and verifies the data to ensure that all data is legitimate. This collection of data and verification allows for a safe, secure and viable community reserve process.

2. The system of claim 1, further comprising of other safety measures where by participants initially will be located at the same place of employment and allows for community reserve to maintain the authenticity and familiarity associated with traditional reserves with the added bonus of security.

3. The system of claim 1, further comprising of a system in which participants' contributions are withdrawn on the participant's payday.

4. The system of claim 1, further comprising of a completely reliable, automated and secure software to conduct and participate in a community reserve.

5. The system of claim 1, further comprising of a procedure where participants do not have to be associated or have a relationship in order to participate in a reserve together.

6. The system of claim 1, further comprising of a procedure, which eliminates dangerous hand-to-hand cash dealings; all transactions are completely automated consisting of electronic transactions.

7. The system of claim 1, further comprising of guarantee weekly, biweekly or monthly disbursements of funds.

8. The system of claim 1, further comprising of variations in the type of reserves offered and in the disbursement of funds, single verses multi disbursements in a single cycle.

9. The system of claim 1, further comprising of steps that will maintain and embrace the attributes, values and the gregarious approach familiar with community reserve participants and combining it with stability, support and security.

10. The system of claim 1, further comprising of procedures that are completely transparent by offering active participants full and easy access to the system to view all transactions related to their reserve.

11. The system of claim 1, further comprising of a system that will fill the need of three groups: those individuals whom participate in community reserves regularly and are familiar with the potential danger traditional community reserves offer, those whom have always been interested in participating but would not subject themselves to the risk and those whom are new to the process.

12. The system of claim 1, further comprising of a procedure in which all participants must make 2 consecutive security deposit contributions into a trust before the reserve begins for the purpose of providing added security to the reserves as well as viability and sustainability.

13. The system of claim 1, further comprising of a system, which allow participants new to a community reserve to select their disbursement date rather than automatically receiving the last disbursements.

14. The system of claim 1, further comprising of procedures that assist participants with always meeting their goals by offering guarantee and on time disbursement of funds.
